(19) United States
(12) Patent Application Publication
(10) Pub. No.: US 2009/0184492 A1
(43) Pub. Date: Jul. 23, 2009

(54) ROLLOVER LIMITING VEHICLE COUPLING APPARATUS

(75) Inventors: Gary Teichrob, Rosedale (CA); Scott McGhee, Rosedale (CA); Dean Scodellaro, Rosedale (CA); Don Poole, Rosedale (CA)

Correspondence Address: PROCOPIO, CORY, HARGREAVES & SAVITCH LLP, 530 B STREET, SUITE 2100, SAN DIEGO, CA, 92101, US

(73) Assignee: Ty-Crop Manufacturing Ltd., Rosedale (CA)

(21) Appl. No.: 12/112,687

(22) Filed: Apr. 30, 2008

Related U.S. Application Data
(60) Provisional application No. 61/021,858, filed on Jan. 17, 2008.

(51) Int. Cl. B60D 1/00; B60D 1/02

(52) U.S. Cl. 280/451; 280/504

(57) ABSTRACT

The present invention provides a rollover limiting vehicle coupling apparatus for coupling two vehicles, wherein apparatus is configured to provide stability in certain directions in one mode of operation, and is further configured to prevent transmission of rollover between vehicles in another mode of operation.

### RELATED APPLICATION

The present application claims the benefit of pending U.S. provisional patent application No. 61/021,858 filed Jan. 17, 2008 which is incorporated herein by reference in its entirety.

### FIELD OF THE INVENTION

The present invention pertains to vehicle-to-vehicle hitches in general and in particular to a rollover limiting vehicle coupling apparatus.

### BACKGROUND

In enterprises such as land/turf management, material is often transported across potentially uneven terrain using a motorized vehicle. This often requires a vehicle capable of maneuvering in such terrain and in tight spots. A combination towing and trailing vehicle connected by a pivotable hitch offers the required maneuverability as well as convenient modularity. Besides acting as a flexible link between the towing and trailing vehicles, a hitch may also transmit stabilizing or destabilizing forces between vehicles, for example forces related to pitching or rolling of the vehicles. While such a hitch may be exploited to increase stability of the vehicle combination, it may also in some cases propagate instability between vehicles, leading to dangerous conditions.

In some cases, in order to provide for a short overall length, and to optimize weight distribution over the axles of both towing and trailing vehicles, the coupling or hitch point of an articulated combination of towing and trailing vehicle may be located overtop of one of the vehicles. This design is used, for example, in standard tractor/trailer and fifth wheel combinations of the kind used by the highway transportation industry. Such a design can provide for increased maneuverability and can reduce potential damage to terrain. However, raising the connection point with respect to the ground increases susceptibility to rollover events. In particular, rolling or tipping of one vehicle may more easily precipitate a rollover of the connected vehicle in this configuration, which can be a dangerous and costly problem. Such a problem can be especially apparent in land/turf management applications, where trailers may carry top-heavy loads over uneven terrain.

The problem of preventing rollover transmission between a tractor and trailer has been considered in a related context by the highway transportation industry, for which rollover can be a significant problem at high speeds. For example, United States Patent Application No. 2005/0006867 discloses a deformable kingpin pivotably connecting a tractor and trailer. The kingpin extends vertically down from the trailer body and comprises a base, shank and deformable head. The shank is inserted into a notch on a fifth wheel assembly mounted on top of the tractor where it is locked in place, with the deformable head and kingpin base sandwiching the fifth wheel assembly. The deformable head is constructed such that during a trailer rollover event, the head deforms allowing the link between tractor and trailer to be broken, allowing the tractor to remain upright.

Due to its construction, the deformable kingpin can have several limitations. The thin, deformable head connects at right angles to the cylindrical shank, which can leave only a narrow interfacial region between deformable and non-deformable material. Due to the small size and orientation of this region, it may be difficult to engineer the deformation threshold with high precision. It may also be difficult to design the deformable head so that it does not completely fracture during rollover, so that the vehicles retain limited connectivity. The circular symmetry of the kingpin and the lack of material at several locations on the deformable head may also result in a lack of pitch resistance for the kingpin device.

Similar but more intricate connection devices are disclosed in U.S. Pat. No. 6,145,864 and U.S. Patent Application No. 2007/0205578. These devices comprise electronic sensors coupled to pneumatic or pyrotechnic devices which actuate to actively disengage the trailer from the tractor under specified conditions. While these devices may be effective, they are also complex and costly to install and maintain, particularly since they are classified as a safety device and so may be subject to strict regulations.

A second approach to preventing transmission of rollover from one vehicle to another is to provide a link which freely rotates about the roll axis of the two vehicles. Hitches comprising a universal or semi-universal joint such as U.S. Pat. No. 3,951,435 have long been available for this purpose for car and trailer type towing arrangements. However, while such hitches naturally prevent transfer of rollover condition from one vehicle to another, they also prevent vehicles from providing torsional stability to one another which might prevent rollover in the first place. This may be especially relevant when towing a trailer with a top-heavy load.

As evidenced by the art cited above, the ability to prevent transmission of rollover is an important consideration when designing a vehicle coupling or hitch. However, in many applications, for example when terrain is variable, it is also important to provide some resistance to both rolling and pitching between the coupled vehicles, so as to provide a sufficiently stable vehicle combination during normal operation. Therefore there is a need for a simple vehicle hitch which can provide a desired resistance to both pitch and roll between vehicles, while substantially preventing transmission of rollover events between vehicles.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a rollover limiting vehicle coupling apparatus. In accordance with an aspect of the present invention, there is provided a coupling apparatus for connecting a first vehicle to a second vehicle, the apparatus comprising: a hitch receiver body connected to the first vehicle and extending toward the second vehicle substantially along an axis of motion of the first vehicle; a hitch member connected to the second vehicle; and an upper flange and a lower flange extending from the hitch receiver body in a spaced-apart configuration, said upper flange and said lower flange configured to pivotally receive the hitch member therebetween, the upper flange and the lower flange further configured to engage the hitch member to limit an angular displacement of the first vehicle with respect to the second vehicle about the axis of motion to a predetermined threshold, wherein at least one of the upper flange and the lower flange is further configured to substantially stop resisting above the predetermined threshold.

### BRIEF DESCRIPTION OF THE FIGURES

FIG. 1 illustrates a view of the assembled hitch receiver and hitch member according to one embodiment of the present invention.

FIG. 2 illustrates the upper flange of the hitch receiver according to one embodiment of the present invention.

FIG. 3 illustrates the lower flange of the hitch receiver according to one embodiment of the present invention.

FIG. 4 illustrates a view of the hitch receiver according to one embodiment of the present invention.

FIG. 5 illustrates a view of the hitch receiver with a connecting pin according to one embodiment of the present invention.

FIG. 6 illustrates a view of the hitch member according to one embodiment of the present invention.

FIG. 7 illustrates a view of the assembled hitch receiver and hitch member, with the hitch receiver engaging the hitch member, to limit relative vehicle roll, according to one embodiment of the present invention.

FIG. 8 illustrates a view of the hitch coupling a first vehicle to a second vehicle, according to one embodiment of the present invention.

### DETAILED DESCRIPTION OF THE INVENTION

### Definitions

The term “flange” as used herein refers to a body extending from another body. A flange may be used, for example to provide a part of a vehicle connection, define part of a cavity, or to increase structural integrity of an assembly of bodies. It is not necessary that a flange increases structural integrity of a body from which it extends.

The term “stress” refers to a condition observed in a material when subjected to an applied force, resulting from factors such as direct loading and twisting. Stress can be defined as a force per unit area. Depending on several factors, including material type, shape, and magnitude and orientation of stress, material under stress may or may not exhibit deformation.

The term “deformation” refers to a change in shape of a material, possibly as a result of stress. Deformation includes but is not limited to strain, twisting, bending, stretching, fracturing, or a combination thereof. Deformation can often be characterized as plastic or elastic deformation, as known in the art. Materials such as steel may exhibit either or both elastic and plastic deformation depending on applied stress.

The term “unrestricted” is used in the context of an object or attribute for which an alternative restricted mode of operation is given. Specifically, the term “unrestricted” is used to describe a condition wherein this restricted mode of operation is not applicable. Use of the term does not necessarily imply that other, possibly unspecified, conditions that might restrict the object or attribute have been removed.

As used herein, the term “about” refers to a ±10% variation from the nominal value. It is to be understood that such a variation is always included in a given value provided herein, whether or not it is specifically referred to.

The hitch or vehicle coupling apparatus described herein normally couples a towing vehicle and a trailing vehicle. However, it is contemplated that the hitch can be operable when the roles of the vehicles are reversed, or equivalently when the hitch system itself is reversed. Therefore the terms “first vehicle” and “second vehicle” can refer to towing and trailing vehicles herein. This terminology is also intended to encompass other possible configurations, such as a first vehicle and second vehicle as any two adjacent vehicles in a train of vehicles, or as vehicles capable of switching between operating roles. Moreover, it is contemplated that a hitch can work to transfer stability in either direction, or to preserve either vehicle in case of rollover of the other.

The relative position of the two vehicles coupled by the hitch may be described with reference to three rotational or angular quantities: “roll”, “pitch”, and “yaw”. These quantities are defined herein as describing deviation of the relative position of the two vehicles from a nominal configuration representative of a normal towing arrangement. For example, the nominal configuration may be congruent to the relative position of the two vehicles as would be exhibited were they moving in the same direction on a flat horizontal surface.

While it is contemplated that other configurations are possible, the terms roll, pitch, and yaw may be generally defined as follows. “Roll” generally refers to rotational deflection from the nominal configuration about an axis parallel to the normal direction of motion of the two vehicles, the axis passing through the vehicle hitch point; “pitch” generally refers to rotational deflection from the nominal configuration about an axis perpendicular to the normal direction of motion but substantially parallel to the upper or lower surfaces of the vehicles, the axis passing through the vehicle hitch point; and “yaw” generally refers to rotational deflection from the nominal configuration about an axis mutually perpendicular to the pitch and roll axes, the axis passing through the vehicle hitch point. In some configurations, rolling may also be described as tipping by a worker skilled in the art.

Unless defined otherwise, all technical and scientific terms used herein have the same meaning as commonly understood by one of ordinary skill in the art to which this invention belongs.

The present invention provides a coupling apparatus for connecting a first vehicle to a second vehicle, the coupling apparatus providing a selected resilience to relative roll and pitch between the first and second vehicles. The coupling apparatus comprises a hitch receiver connected to the first vehicle, and a hitch member connected to the second vehicle. The hitch receiver extends from the first vehicle toward the second vehicle, and has, as further extensions, an upper flange and a lower flange arranged in a spaced-apart configuration. The upper and lower flanges are configured to pivotally receive the hitch member therebetween, and are configured to engage the hitch member to limit relative roll of the two vehicles in one mode of operation, and to allow substantially unrestricted roll in another mode of operation, for example during a potential rollover condition of the first or second vehicle relative to the other.

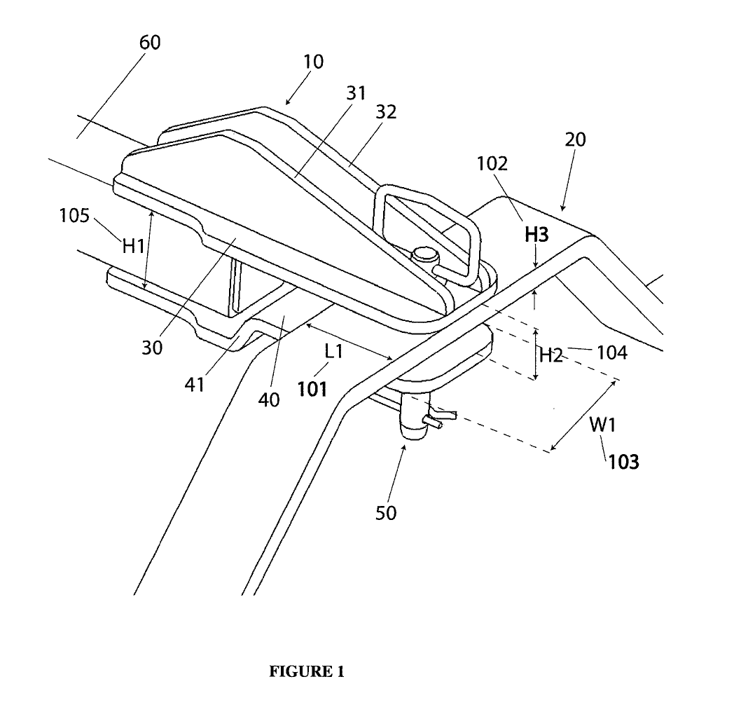

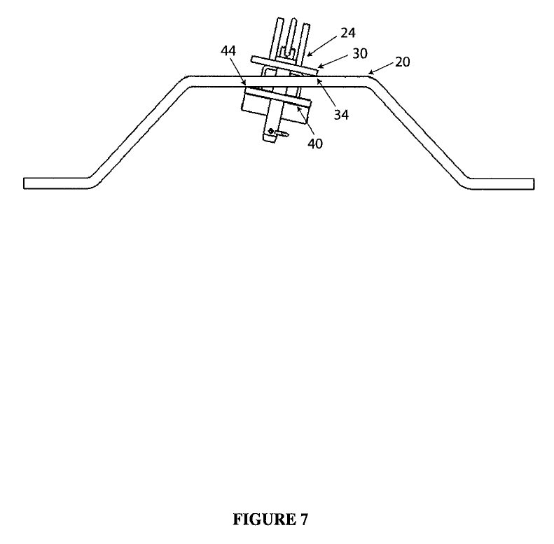

FIG. 1 illustrates a close-up view of a coupling apparatus according to one embodiment of the present invention, wherein the coupling apparatus is illustrated in a normal towing arrangement. The hitch receiver 10 is coupled to the hitch member 20 by receiving the hitch member 20 between the upper flange 30 and the lower flange 40 of the hitch receiver. Relative roll of the hitch member between the flanges will, at a certain angle, result in the flanges engaging the hitch member as shown in FIG. 7, thereby restricting further relative roll. However, the construction of the coupling apparatus and materials thereof are such that stresses induced by relative roll, which are above a predetermined threshold, will result in a deformation in the coupling apparatus which substantially removes this engagement, allowing substantially unrestricted relative roll thereafter between a first vehicle and a second vehicle.

### Hitch Receiver

The hitch receiver comprises a hitch receiver body connected to the first vehicle, the body extending toward the second vehicle along an axis of normal direction of motion of the first vehicle. Extending from the hitch receiver body are an upper flange and a lower flange, which are spaced apart so as to allow a portion of the hitch member to be received between the flanges. With the hitch member received in this manner, a pivotable towing connection may be established, allowing relative rotation of the two vehicles about a yaw axis passing through the hitch.

In one embodiment, the hitch receiver comprises a hitch receiver body with an upper flange and a lower flange attached to the top and bottom of the hitch receiver body, respectively.

In another embodiment, the hitch receiver comprises a hitch receiver body with an upper flange and a lower flange, one or both of the upper and lower flanges extending from intermediate portions of the hitch receiver body, which are located between the top and bottom of the hitch receiver body.

In another embodiment, the hitch receiver comprises a hitch receiver body coupled to a single shaped or curved component, such as a shaped component defining a yoke. In this embodiment, opposite ends of the shaped or curved component comprise an upper flange and a lower flange.

In one embodiment, at least one of the upper flange and lower flange act to limit relative roll in one mode of operation but to allow substantially unrestricted roll in another mode. In one embodiment, this dual-mode operation is facilitated by the material and construction of one or both of the flanges. For example, relative roll between the first and second vehicle may initially cause corresponding roll of the hitch member between the upper and lower flange. At a predetermined, possibly negligible, roll angle induced between the two vehicles, at least one of the upper and lower flanges will engage the hitch member to resist further rolling. At this point, in one embodiment, additional rolling stress may result in elastic deformation of at least one part of the hitch receiver or hitch member, leading to further relative roll between the two vehicles. At a predetermined threshold the engaging activity of the flanges resisting roll ceases. In one embodiment, at least one of the upper and lower flanges is configured to plastically deform at or near the threshold for this purpose. In another embodiment, at least one of the upper and lower flanges is configured to fracture at or near the threshold for this purpose.

The predetermined threshold at which the engaging activity of the flanges resisting roll substantially ceases, as well as the type of deformation exhibited by the vehicle coupling near or beyond the predetermined threshold, can be influenced by several factors during construction or configuration of the vehicle coupling apparatus. For example, the shape of the coupling apparatus and the materials comprising various portions thereof can substantially influence the predetermined threshold.

In one embodiment, increasing the thickness of either or both of the upper flange and the lower flange can increase the predetermined threshold. Thicker flanges will typically not bend as readily under rolling stress, thereby providing for a vehicle coupling that can be more rigid about the rolling axis.

In one embodiment of the present invention, the hitch receiver body is configured such that under substantially all loading conditions, the hitch receiver body only undergoes elastic deformation. This configuration of the hitch receiver body can enable the deformation to be isolated within one or more of the upper flange, lower flange and hitch member.

In one embodiment, varying the length of either or both of the upper flange and the lower flange along an axis parallel to the roll axis can influence the predetermined threshold. Longer upper and lower flanges may increase the tendency for elastic or plastic deformation of same due to rolling stress, thereby influencing the predetermined threshold.

In one embodiment, varying the width of one or more of the upper flange, the lower flange, and the hitch receiver body along an axis parallel to the pitch axis (that is, along the left-right axis of the vehicle) can influence the predetermined threshold. For example, increasing the width of the flanges can cause increased torsional stress to be applied by the hitch member when engaged by the upper and lower flanges, thereby influencing the predetermined threshold. At the same time, increased width of the flanges may decrease the amount of relative vehicle roll possible before the hitch member is engaged by the upper flange and the lower flange.

Other shape modifications, such as providing curved, corrugated, variable thicknesses, or reinforcement at portions of the hitch receiver, may, depending on the particular embodiment of the invention, influence the predetermined threshold as would be known to a worker skilled in the art. For example, appropriate curving of the hitch receiver around an axis parallel to the roll axis can result in a more continuous increase in stress conditions in the hitch receiver as relative vehicle roll progresses.

In one embodiment, the flanges are of differing thickness. One purpose for varying the thickness is to adjust the stress versus deformation relationship of a flange in order to influence the predetermined threshold.

The materials used in various portions of the vehicle coupling apparatus may also affect the predetermined threshold as well as behaviour near or beyond the predetermined threshold. For example, if the upper and lower flanges comprise a relatively ductile material such as mild steel, then the hitch may exhibit a greater degree of plastic deformation near or beyond the predetermined threshold. If the upper and lower flanges comprise a relatively brittle material such as high strength steel, then the hitch may exhibit a lesser degree of plastic or elastic deformation before fracture. Other materials, such as aluminum or various alloys, may exhibit still further differences in both the threshold value and deformation behaviour. The behaviour of a wide variety of suitable materials is known in the art. Thus, a hitch which deforms under desired conditions and in a desired manner may be provided by selection of appropriate material and dimensions of the coupling apparatus.

Behaviour at or near the predetermined threshold at which the vehicle coupling apparatus operates due to rolling stress may be further influenced by the selection of fastening means used in its construction. For example, bolts, welds, holes, screws, hooks, or other fastening means may influence the predetermined threshold and the behaviour of the vehicle coupling at or near same. Design of the vehicle coupling may compensate for or rely upon such influences. The shape and materials used in the vehicle coupling apparatus may also influence the selection of fastening means.

In one embodiment, conditions in the vehicle coupling reach the predetermined threshold before the vehicles exhibit a relative amount of roll that would lead to transmission of a rollover condition from one vehicle to another. The relative amount of roll leading to rollover transmission may be a function of the configuration, orientation, and/or loading of the vehicles or the vehicles themselves. Such a predetermined threshold can contribute to a desired stability of a vehicle, by eliminating a significant source of potential rollovers.

In the case of preventing transmission of rollover from the first vehicle to the second vehicle, determination of an appropriate predetermined threshold can comprise consideration of factors such as the weight of the second vehicle plus any other load such as an on-board operator, as well as dimensions such as the height of the vehicle coupling point, the width of the second vehicle, the orientation of the vehicle coupling apparatus, and possibly the vehicle coupling itself. Physical calculations based on these considerations can predict an amount of load that can be applied to the vehicle coupling to initiate rollover of the second vehicle. A maximum safe load can be set by multiplying the determined amount of load initiating rollover by a desired safety factor, said safety factor being less than one. The safety factor can account for errors in measurement, changes to the weight of the second vehicle, operation on a slope, etc. The desired predetermined threshold at which the vehicle coupling operates to prevent rollover can be set such that conditions in the vehicle coupling reach the predetermined threshold substantially at or before the maximum safe load is applied to the second vehicle. In this manner, the vehicle coupling can operate to prevent rollover before a rollover event is initiated.

In one embodiment, the dimensions of the upper and lower flanges, and the spacing therebetween, are configured to allow for a predetermined amount of unrestricted roll before the flanges engage the hitch member. Such “play” in the vehicle coupling can accommodate a degree of relative roll commensurate with normal vehicle operation without introducing stress or fatigue in the vehicle coupling, which could impact operation at the predetermined roll threshold.

The amount of unrestricted roll allowed before the flanges engage the hitch member can be varied by adjustment of dimensions in the vehicle coupling. For example with reference to FIG. 1, which illustrates a coupling apparatus according to one embodiment of the present invention, a positive difference x between thickness H3 102 and gap width H2 104 facilitates some amount of unrestricted roll. The roll is restricted by the upper flange and the lower flange depending on a value y equal to flange width W1 103. The maximum roll angle between the first and second vehicles in this configuration, as a deflection from the normal towing arrangement, can be calculated as being about:

θ=tan⁻¹(x/y). (1)

To obtain a desired amount of unrestricted roll, one, some or all of dimensions H3 102, H2 104, and W1 103 can be adjusted, thereby adjusting x and y, provided that these dimensions are appropriate for other functions, such as towing and determination of the predetermined threshold.

In another embodiment, the hitch receiver is curved or shaped such that no substantial “play” is exhibited. In such an embodiment, the amount of stress applied to the vehicle coupling due to roll may vary continuously with the amount of roll of the first vehicle with respect to the second vehicle.

In one embodiment, the amount of unrestricted roll before the hitch member is engaged by the flanges, and the predetermined threshold at which the engagement of the hitch member by the flanges substantially ceases, can both be dependent on common structural parameters. For example, the dimensions of the upper and lower flanges and the spacing therebetween, may contribute to determination of each of said functions. Therefore, it may be required to select the dimensions of the vehicle coupling so as to satisfy multiple objectives. In this case, material selection and the inclusion of extra structural features may become more important.

In one embodiment, at least one of the upper and lower flanges provides resistance to relative pitching of the two vehicles. In one embodiment, reinforcement is provided for this purpose, for example through the attachment of one or more stiffeners arrayed with their strong axis perpendicular to the flange.

In one embodiment, weakening features such as bends, notches, or holes may be included in one or more of the upper flange and lower flange. Strategically placed weakening features may lower the predetermined threshold to achieve desired operation.

In one embodiment, the dimensions of the upper and lower flanges, and the spacing therebetween, are configured to allow for a predetermined amount of unrestricted pitch before one or both of the flanges engage the hitch member to resist relative pitching between the two vehicles.

To ensure a sufficiently strong connection between hitch receiver and hitch member, additional attachment means may be required. In one embodiment, holes are provided in each of the upper and lower flanges and in the hitch member, through which a connecting body, for example a pin, may be passed. In one embodiment, the connecting body is substantially vertical in orientation and passes through holes which are substantially concentric. In one embodiment, the diameters of the connecting body and of each hole are configured to allow a predetermined region of unrestricted rolling of the connecting body within the hole. For example, the relative diameters of the connecting body and the hole in the hitch member through which it passes can be selected to accommodate a relative amount of roll greater than or equal to the roll accommodated by Equation (1). In this case, rolling stresses induced in the connecting body can be reduced.

In one embodiment, the connection may comprise additional features. For example, at least one of the holes through which the connecting body is passed may be provided with a pliable material, such as rubber, which reduces wear caused by contact between the connecting body and the material surrounding the holes.

In another embodiment, a connecting body allowing pivot about the yaw axis may be attached to one of the upper and lower flange and the hitch member, which may be received by the remaining two of the upper flange, lower flange and hitch member to provide the connection.

In another embodiment, the flanges are coupled to the hitch member by an attachment system comprising a bearing assembly, the bearing assembly can allow for relative yaw between the two vehicles and optionally can allow for relative pitch and roll. Unnecessary or undesired forces on the bearing assembly may be reduced by relying on engagement of the flanges with the hitch member to resist relative pitching and rolling of the two vehicles.

### Hitch Member

The hitch member comprises a body attached to the second vehicle. A towing connection may be provided by coupling the hitch member to the hitch receiver at a portion of the hitch member intended for that purpose.

In one embodiment, the hitch member comprises an elongated body, connected at distal ends to the second vehicle. The hitch member may also comprise a coupling portion substantially in the centre of the hitch member to be received by the hitch receiver in a normal towing arrangement.

In one embodiment, the coupling portion of the hitch member is raised from the body of the second vehicle. This may allow the hitch to be located overtop of the second vehicle, thereby shortening the length of the hitched vehicle combination and allowing vehicle loads to be distributed over more vehicle axles.

In one embodiment, the hitch member comprises a portion which deforms when subjected to rolling stress above a threshold.

Materials, shape, dimensions, and the provision of strengthening or weakening elements, may all be modified or provided in the hitch member in the same manner and for analogous purposes as in the hitch receiver. It is to be understood that shaping and dimensioning should not substantially impact the ability to receive the hitch member between the flanges of the hitch receiver.

In one embodiment, the thickness of the hitch member is selected so as to determine a substantially maximum roll angle θ in Equation (1), which can be the maximum angle of relative roll between the first and second vehicle before the hitch member is engaged by the upper flange and the lower flange.

In one embodiment, the hitch member may be curved in a complementary fashion to fit with curved portions of the hitch receiver. Appropriate curving of the hitch member and portions of the hitch receiver around axes parallel to the roll axis can result in a more continuous and controllable variation in stress conditions introduced in the hitch receiver as relative vehicle roll varies.

In one embodiment, the hitch member is of sufficient shape, thickness and strength of material such that the predetermined threshold is reached before substantial deformation of the hitch member occurs.

The invention will now be described with reference to specific examples. It will be understood that the following examples are intended to describe embodiments of the invention and are not intended to limit the invention in any way.

### EXAMPLE

FIG. 1 illustrates an embodiment of the present invention, having a hitch receiver and a hitch member 20, operatively coupled by a connecting body 50 comprising a pin. The hitch receiver 10 comprises an upper flange 30 and a lower flange 40, fastened to top and bottom of a hitch receiver body 60. The upper flange 30 further comprises stiffeners 31 and 32, which reinforce upper flange 30 against stress due to relative motion, such as pitching, of the first vehicle with respect to the second vehicle.

FIG. 1 also illustrates several dimensional quantities which affect operation of the hitch. The distance H2 104 between upper flange 30 and lower flange 40 is greater than the thickness H3 102 of the hitch member 20, thereby allowing for a degree of rolling and pitching before the hitch member 20 is engaged by the upper flange 30 and lower flange 40. The degree of rolling and pitching allowed is affected by width W1 103 and width L1 101, respectively, and can be approximated by Equation (1). Bend 41 in the lower flange 40 allows distance H2 104 to be configured independently of distance H1 105, thereby allowing for additional freedom of configuration of the hitch, while holding fixed the dimensions of the hitch receiver body 60.

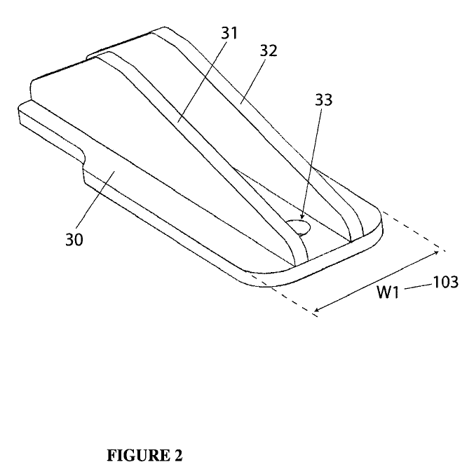

FIG. 2 is a detailed illustration of the upper flange 30 in the example embodiment. In this view is shown a hole 33 passing through upper flange 30, the hole 33 being of sufficient diameter to accommodate connecting body 50, as shown in FIG. 1.

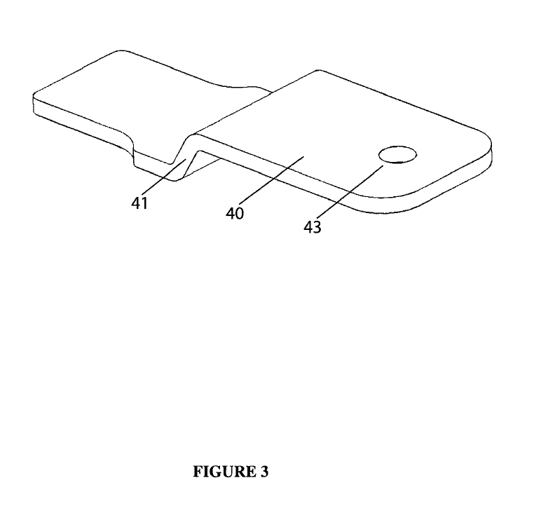

FIG. 3 is a detailed illustration of the lower flange 40 in the example embodiment. In this view is shown a hole 43 passing through lower flange 40, the hole 43 being of sufficient diameter to accommodate connecting body 50, as shown in FIG. 1. Hole 33 and hole 43 can be concentric in the assembled vehicle coupling, such that a straight connecting body 50 oriented along a yaw axis, substantially normal to the vehicle surface, may pass through both.

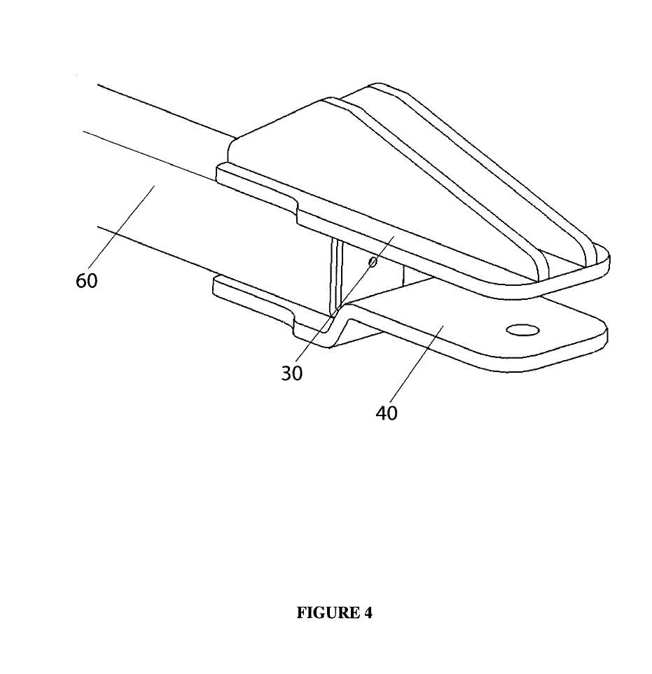

FIG. 4 illustrates upper flange 30 and lower flange 40 connected to hitch receiver body 60 in the example embodiment. Means of connection may include bolts, welds, or any other appropriate mechanical connection means. Alternatively one continuous piece of material may comprise the upper flange 30, stiffeners 31 and 32, lower flange 40, and hitch receiver body 60, for example if a casting process were used in creation of the hitch receiver 10.

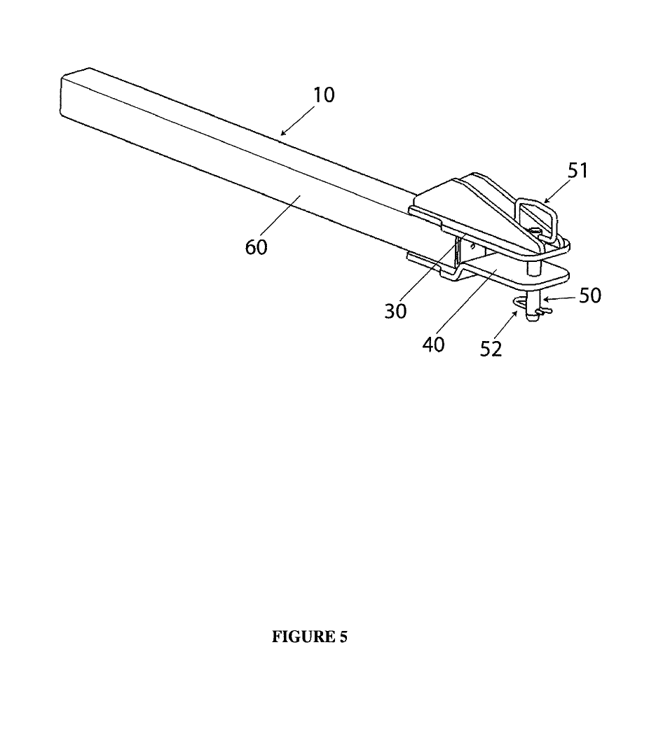

FIG. 5 illustrates a view of hitch receiver 10 in the example embodiment, including a full view of the hitch receiver body 60. Connecting body 50 passes through the concentric holes 33 and 43 in the upper flange 30 and lower flange 40, respectively. A handle 51 and a cotter pin 52 are provided for easy handling of the connecting body 50, and to help ensure the connecting body 50 remains in the required position during normal operation. For illustrative purposes the hitch member 20 is not shown in this figure.

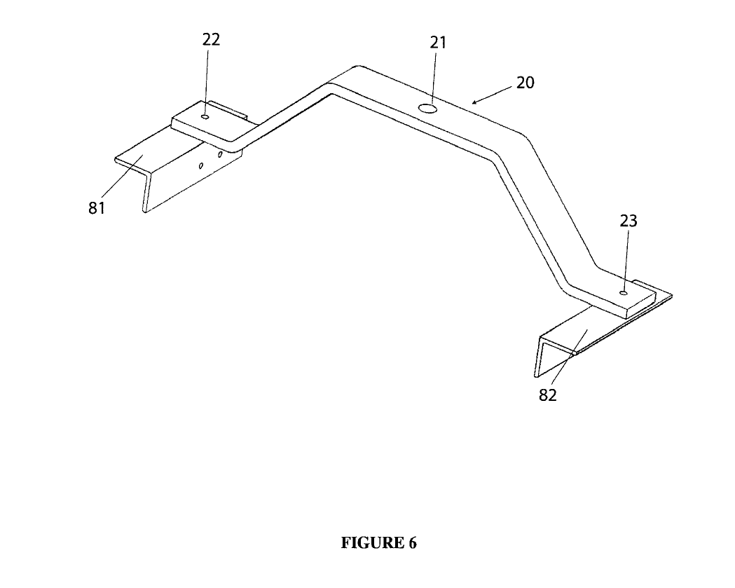

FIG. 6 illustrates hitch member 20, connected to the second vehicle in the example embodiment. As illustrated, hitch member 20 is mounted to vehicle body component 81 via mounting hole 22, and to vehicle body component 82 via mounting hole 23. In one embodiment, bolts are provided for this purpose, although other means of connection are possible. Hole 21 provides a connection to hitch receiver 10 by aligning hole 21 with holes 33 and 43 and passing connecting body 50 through all three holes. To allow for relative pitch and roll, hole 21 may be larger in diameter than either holes 33 and 43, and may be elliptical or otherwise shaped to accommodate desired amounts of relative pitch and roll.

FIG. 7 illustrates the hitch of the example embodiment under relative rolling of the first vehicle with respect to the second vehicle. As shown, the angle between hitch receiver 10 and hitch member 20 induced by the roll causes upper flange 30 to engage hitch member 20 at contact region 34, and lower flange 40 to engage hitch member 20 at contact region 44. An oblique angle is thereby formed between the hitch receiver 10 and the hitch member 20, and between connecting body 50 and hitch member 20. The angle is influenced by the dimensions of the vehicle coupling and the relative diameters of the connecting body 50 and the hole 21. Since the materials of the vehicle coupling are resilient to some amount of mechanical stress, forces tending to promote roll beyond the level at which the engagement shown first occurs will introduce stresses in the vehicle coupling, and in particular at contact regions 34 and 44. When these stresses exceed a predetermined threshold, at least one of the hitch member 20, upper flange 30, or lower flange 40 is configured, due to its material and construction, to stop resisting the induced stresses. For example the lower flange 40 may undergo deformation, thereby allowing rollover of one vehicle while allowing the other vehicle to remain upright.

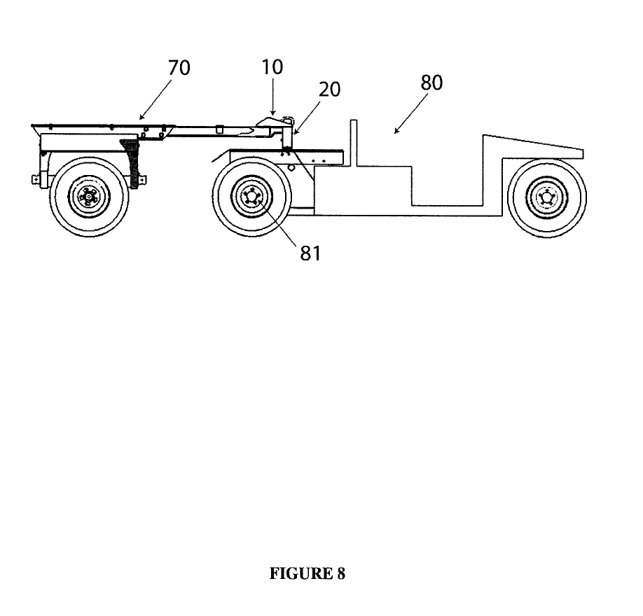

FIG. 8 illustrates the coupling of first vehicle 70 to second vehicle 80 via the hitch of the example embodiment, wherein the hitch receiver 10 receives the hitch member 20 in a normal towing arrangement. To provide for a short overall length and optimal weight distribution, the hitch member 20 is placed overtop of the second vehicle 80, forward of axle 81.

It is obvious that the foregoing embodiments of the invention are examples and can be varied in many ways. Such present or future variations are not to be regarded as a departure from the spirit and scope of the invention, and all such modifications as would be obvious to one skilled in the art are intended to be included within the scope of the following claims.

We claim:

1. A coupling apparatus for connecting a first vehicle to a second vehicle, the apparatus comprising:
a) a hitch receiver body connected to the first vehicle and extending toward the second vehicle substantially along an axis of motion of the first vehicle;
b) a hitch member connected to the second vehicle; and
c) an upper flange and a lower flange extending from the hitch receiver body in a spaced-apart configuration, said upper flange and said lower flange configured to pivotally receive the hitch member therebetween, the upper flange and the lower flange further configured to engage the hitch member to limit an angular displacement of the first vehicle with respect to the second vehicle about the axis of motion to a predetermined threshold, wherein at least one of the upper flange and the lower flange is further configured to substantially stop resisting above the predetermined threshold.

2. The coupling apparatus according to claim 1, wherein at least one of the upper flange and lower flange is configured to plastically deform substantially at the predetermined threshold.

3. The coupling apparatus according to claim 1, wherein at least one of the upper flange and lower flange is configured to fracture substantially at the predetermined threshold.

4. The coupling apparatus according to claim 1, wherein the upper flange has a first thickness and the lower flange has a second thickness, wherein the first thickness is different from the second thickness.

5. The coupling apparatus according to claim 1, wherein one or both of the upper flange and the lower flange are fabricated from a ductile material.

6. The coupling apparatus according to claim 1, wherein one or more stiffeners are connected to the upper flange.

7. The coupling apparatus according to claim 1, wherein one or both of the upper flange and the lower flange comprise one or more weakening features.

8. The coupling apparatus according to claim 7, wherein the one or more weakening features comprise: bends, notches and holes.

9. The coupling apparatus according to claim 1, wherein the upper flange and the lower flange are respectively connected to the top and bottom of the hitch receiver body.

10. The coupling apparatus according to claim 1, wherein the hitch receiver body is configured to only deform elastically.

11. The coupling apparatus according to claim 1, wherein the predetermined threshold is determined as a fraction of a load which would result in rollover of either the first vehicle of the second vehicle.

12. The coupling apparatus according to claim 1, wherein the first vehicle is a towing vehicle and the second vehicle is a towed vehicle.
